(19) United States
(12) Patent Application Publication
(10) Pub. No.: US 2008/0309106 A1
(43) Pub. Date: Dec. 18, 2008

(54) ROOT CUTTING SHOVEL

(76) Inventor: William J. Baker, Naples, FL (US)

Correspondence Address: EDWARD M. LIVINGSTON, PA, 963 TRAIL TERRACE DRIVE, NAPLES, FL, 34103, US

(21) Appl. No.: 11/763,859

(22) Filed: Jun. 15, 2007

(51) Int. Cl. A01B 1/04

(52) U.S. Cl. 294/49

(57) ABSTRACT

A root cutting shovel (1) having a concave head (2) of a predetermined size and shape having a top (3) and a tip (4) wherein the head (2) has a front face (16) and a rear face (17). The head top (3) has a first end (13) and a second end (14) and a center (12) located between the first and second ends (13 and 14). A first edge (8) extends from the head first end (13) to the tip (4) while a second edge (9) extends from the head second end (14) to the tip (4). A plurality of serrated teeth (15) extend along the first and second edges (8 and 9) wherein each tooth (15) has a first side (27) and a second side (28) which join together at a predetermined angle (29), which is approximately sixty degrees. An elongated handle (6) is secured to the head top center (12) and flanges (10 and 11) are located on either side of the handle (6) and extend away from the head front face (16).

### BACKGROUND OF THE INVENTION

This invention relates to shovels, more particularly, a root cutting shovel that permits a person to quickly and easily dig a hole through a root-infused ground.

Shovels are the preferred tool of choice when removing a small amount of soil, dirt, debris and other items from a ground surface. Most also have a predetermined concave area on a shovel head to hold the soil, dirt, debris, etc., hereinafter referred to as a load, and permit a person to transport the load from one location to another. Over time, shovels have become modified to perform a variety of tasks in addition to removing and moving a load. For instance, various types of shovels have different structural elements to permit a user to pierce through a ground surface, scoop a larger load, dig a wider hole and the like.

Although there have been advancements in the structure of the shovel, which in turns affect the purpose of the shovel, current shovels do not adequately address the problem associated with digging in a ground infused with roots. Although a person may use a traditional shovel to repeatedly hit the roots, thereby weakening and eventually breaking the roots, the process of doing so is not only time-consuming, but also very physically demanding.

Thus, a need exists for a root cutting shovel that permits a person to quickly and easily dig a hole through a root-infused ground.

The relevant prior art includes the following references:

| U.S. Pat. No. | | |
|---|---|---|
| (U.S. unless stated otherwise) | Inventor | Issue/Publication Date |
| Des. 362,601 | Jackson | Sep. 26, 1995 |
| 5,951,077 | Dahill | Sep. 14, 1999 |
| 808,168 | Reed | Dec. 26, 1905 |
| 3,110,349 | Means | Nov. 12, 1963 |
| Des. 397,279 | Rich et al. | Aug. 25, 1998 |
| Des. 388,292 | Rich et al. | Dec. 30, 1997 |
| 1,263,949 | Singer | Apr. 23, 1918 |
| 3,848,915 | Wherry | Nov. 19, 1974 |

### SUMMARY OF THE INVENTION

The primary object of the present invention is to provide a root cutting shovel that permits a person to quickly and easily dig a hole through a root-infused ground.

A further object of the present invention is to provide a root cutting shovel that deeply penetrates a ground surface.

An even further object of the present invention is to provide a root cutting shovel that may be used to fillet grass.

Another object of the present invention is to provide a root cutting shovel that may be used to extract shrubs and bushes.

The present invention fulfills the above and other objects by providing a root cutting shovel having a concave head of a predetermined size and shape having a top and a tip wherein the head has a front face and a rear face. The head top has a first end and a second end and a center located between the first and second ends. A first edge extends from the head first end to the tip while a second edge extends from the head second end to the tip. A plurality of serrated teeth extend along the first and second edges wherein each serrated tooth has a first side and a second side which join together, preferably at a sixty degree angle, to form an apex, and a tooth edge. An elongated handle is secured to the head top center and flanges are located on either side of the handle and extend away from the head front face.

To use the present invention, a user inserts the tip of the head into a ground surface desired to be dug into. Then, the user exerts a predetermined amount of force on the head via the handle to push the head deeper and deeper into the ground. If roots are located within the ground, the serrated teeth located along the first and second edges of the head act to grind and cut through the roots, thereby permitting a user to easily dig through the root-infused ground. If a greater amount of force is necessary, the user may place his or her foot on one or both of the flanges and step down on one or both of the flanges in order to provide a greater downward force on the head of the shovel.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a front view of a root cutting shovel of the present invention;

FIG. 2 is an enlarged view of a head of the root cutting shovel of the present invention;

FIG. 3 is a side view of the root cutting shovel of the present invention; and

FIG. 4 is an enlarged view of a plurality of teeth located on the root cutting shovel of the present invention.

### DESCRIPTION OF THE PREFERRED EMBODIMENTS

For purposes of describing the preferred embodiment, the terminology used in reference to the numbered components in the drawings is as follows:

```
  1. root cutting shovel, generally
  2. head
  3. top
  4. tip
  5. retaining portion
  6. handle
  7. grip
  8. first edge
  9. second edge
10. first flange
11. second flange
12. center
13. first end
14. second end
15. teeth
16. front face
17. rear face
18. handle distal end
19. first linear portion
20. second linear portion
21. first linear portion edge
22. second linear portion edge
23. tooth edge
24. apex
25. tip edge
26. handle proximal end
27. tooth first side
28. tooth second side
29. angle
```

With reference to FIG. 1, a front view of a root cutting shovel of the present invention is shown. The root cutting shovel, generally 1, includes a head 2 having a front face 16, a top 3 and a tip 4 wherein the head 2 is secured to a distal end 18 of an elongated handle 6, preferably at a center 12 of the top 3. The head 2 is of a predetermined size and shape is preferably concave so as to provide a retaining portion 5 within a central area of the head 2. The head 2 includes a first edge 8 extending between a first end 13 of the top 3 and the tip 4 and a second edge 9 extending between a second end 14 of the top 3 and the tip 4. A plurality of serrated teeth 15 are located along the first edge 8 and second edge 9 of the head 2. A first flange 10 and a second flange 11 extend between the first end 13 and center 12 and between the center 12 and the second end 14, respectively. A first linear portion 19 and a second linear portion 20 extend between the first end 13 and the first edge 8 and the second end 14 and the second edge 9, respectively. A grip 7 is preferably provided at a handle proximate end 26 to permit a user to easily hold and use the root cutting shovel 1.

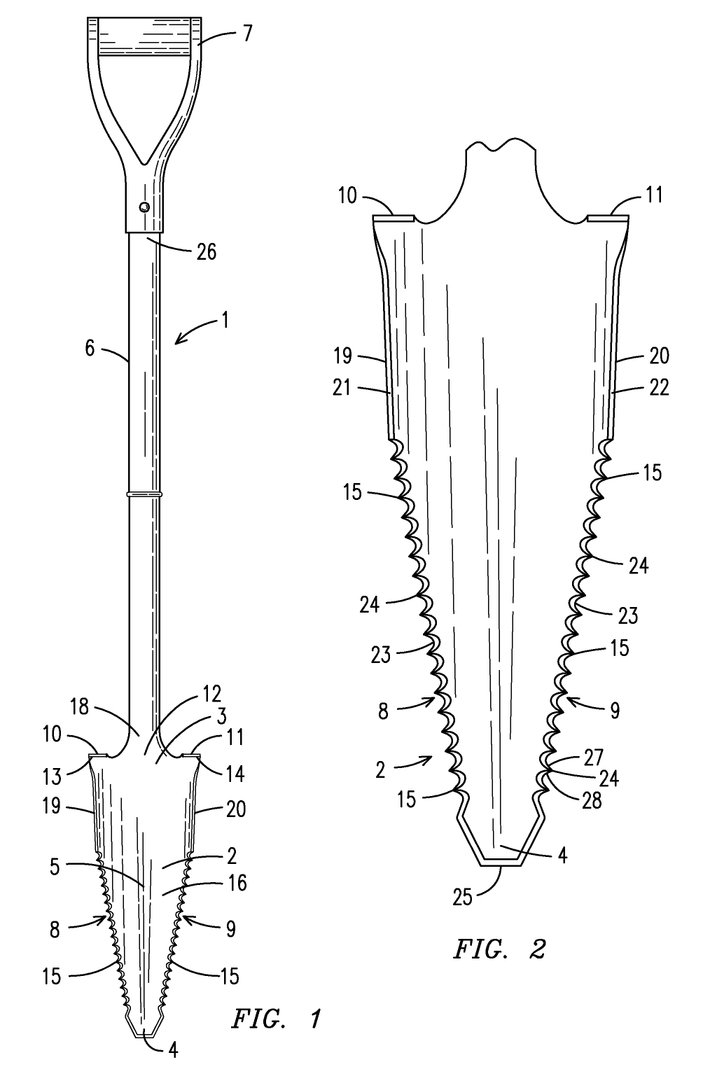

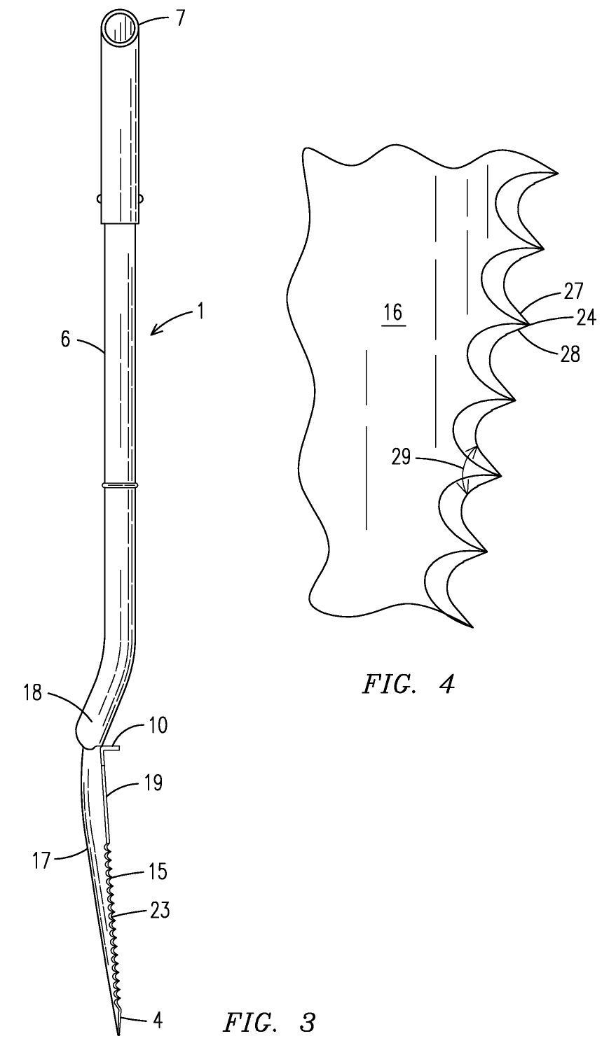

Next, FIG. 2 shows an enlarged view of a head of the root cutting shovel of the present invention. The head 2 includes a plurality of teeth 15 located along the first and second edges 8 and 9 of the head 2. Each tooth 15 has a first side 27 and a second side 28 which join together at a predetermined angle 29 (see FIG. 4) to form an apex 24. Each tooth 15 also has a tooth edge 23 wherein the edge extends from the front face 16 of the head 2 to a rear face 17 of the head 2 (as shown in FIG. 3). A first linear portion edge 21 and a second linear portion edge 22 extend along the first linear portion 19 and second linear portion 20, respectively and extend from the front face 16 of the head 2 to the rear face 17 of the head 2 as well (see FIG. 3). In addition, the tip 4 has a has a tip edge 25 which also extends from the front face 16 of the head 2 to the rear face 17 of the head 2 (see FIG. 3). The tooth edges 23, linear portion edges 21 and 22 and tip edge 25 are similar in structure, appearance and function to a knife edge and are of great importance as they provide the working part of the root cutting shovel 1 when the root cutting shovel 1 is used to cut roots. Although the tip 4 is shown as being substantially flat, the tip 4 may have various shapes, such as a rounded shape, pointed shape, squared-off shape, etc.

FIG. 3 shows a side view of the root cutting shovel of the present invention. The root cutting shovel 1 preferably has a concave head 2 so as to permit holding and retaining of loads. The handle distal end 18 is preferably angled so as to provide a greater stability and construction of the root cutting shovel 1. The flanges 10 and 11 preferably extend a predetermined distance away from the rear face 17 of the root cutting shovel 1 so as to provide a location in which a user may place his or her foot thereon to provide greater downward force on the root cutting shovel 1 when in use.

Finally, FIG. 4 shows an enlarged view of a plurality of teeth located on the root cutting shovel of the present invention. Each tooth 15 has a first side 27 and a second side 28 which join together at a predetermined angle 29 to form an apex 24. Although the preferred angle 29 is approximately sixty degrees, the angle 29 may be any angle between a range of approximately twenty to ninety degrees.

To use the root cutting shovel 1 of the present invention, a person first selects the area in which he or she would like to dig. Then, he or she inserts the tip 4 of the head 2 into the ground and commences digging as when using a conventional shovel. If the user comes across a root or other underground impediment, then he or she uses the tip edge 25, teeth edges 23 and, if needed, linear portion edges 21 and 22 to cut or saw the roots or impediments. If cutting an especially thick root or impediment, the user may then place one or both feet on the flanges 10 and 11 to exert a greater downward force on the root cutting shovel 1.

The use of the present invention will permit a person to quickly and easily dig a hole through a root-infused ground.

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not be considered limited to what is shown and described in the specification and drawings.

Having thus described my invention, I claim:

1. A root cutting shovel comprising:
a concave head of a predetermined size and shape having a top and a tip;
said head having a front face and a rear face;
said top having a first end and a second end;
said top having a center located between said first end and said second end;
a first edge extending from said head first end to said tip;
a second edge extending from said head second end to said tip;
a plurality of serrated teeth extending along said first edge;
a plurality of serrated teeth extending along said second edge;
each serrated tooth extending along said first edge having a first side and a second side which join together to form an apex;
a predetermined angle formed by said each serrated tooth first side and said tooth second side on said first edge joining together;
each serrated tooth extending along said second edge having a first side and a second side which join together to form an apex;
a predetermined angle formed by said each serrated tooth first side and said tooth second side on said second edge joining together;
each serrated tooth along said first edge and said second edge having a tooth edge;
an elongated handle secured to said top center;
a first flange located on said top between said first end and said center; and
a second flange located on said top between said second end and said center.

2. The root cutting shovel of claim 1 wherein:
wherein said first flange extends a predetermined distance from said head front face.

3. The root cutting shovel of claim 1 wherein:
wherein said second flange extends a predetermined distance from said head front face.

4. The root cutting shovel of claim 2 wherein:
wherein said second flange extends a predetermined distance from said head front face.

5. The root cutting shovel of claim 1 wherein:
said predetermined angle of each serrated tooth extending along said first edge is approximately sixty degrees.

6. The root cutting shovel of claim 1 wherein:
said predetermined angle of each serrated tooth extending along said second edge is approximately sixty degrees.

7. The root cutting shovel of claim 5 wherein:
said predetermined angle of each serrated tooth extending along said second edge is approximately sixty degrees.

8. The root cutting shovel of claim 1 wherein:
said predetermined angle of each serrated tooth extending along said first edge is approximately between twenty and ninety degrees.

9. The root cutting shovel of claim 1 wherein:
said predetermined angle of each serrated tooth extending along said second edge is approximately between twenty and ninety degrees.

10. The root cutting shovel of claim 8 wherein:
said predetermined angle of each serrated tooth extending along said second edge is approximately between twenty and ninety degrees.

11. The root cutting shovel of claim 1 further comprising:
a substantially vertical first linear portion located on said first edge and extending between said top first end and said plurality of serrated teeth extending along said first edge; and
said substantially vertical first linear portion having a first linear portion edge.

12. The root cutting shovel of claim 1 further comprising:
a substantially vertical second linear portion located on said second edge and extending between said top second end and said plurality of serrated teeth extending along said second edge; and
said substantially vertical second linear portion having a second linear portion edge.

13. The root cutting shovel of claim 11 further comprising:
a substantially vertical second linear portion located on said second edge and extending between said top second end and said plurality of serrated teeth extending along said second edge;
said substantially vertical second linear portion having a second linear portion edge.

14. The root cutting shovel of claim 1 wherein:
said head tip has a head tip edge.

15. A root cutting shovel comprising:
a concave head of a predetermined size and shape having a top and a tip;
said head having a front face and a rear face;
said top having a first end and a second end;
said top having a center located between said first end and said second end;
a first edge extending from said head first end to said tip;
a second edge extending from said head second end to said tip;
a plurality of serrated teeth extending along said first edge;
a plurality of serrated teeth extending along said second edge;
each serrated tooth extending along said first edge having a first side and a second side which join together to form an apex;
a sixty degree angle formed by said each serrated tooth first side and said tooth second side on said first edge joining together;
each serrated tooth extending along said second edge having a first side and a second side which join together to form an apex;
a sixty degree angle formed by said each serrated tooth first side and said tooth second side on said second edge joining together;
an elongated handle secured to said top center of said head;
a first flange located on said top between said first end and said center;
said first flange extends a predetermined distance from said head front face; and
a second flange located on said top between said second end and said center;
said second flange extends a predetermined distance from said head front face.

16. The root cutting shovel of claim 15 further comprising:
a substantially vertical first linear portion located on said first edge and extending between said top first end and said plurality of serrated teeth extending along said first edge; and
said substantially vertical first linear portion having a first linear portion edge.

17. The root cutting shovel of claim 15 further comprising:
a substantially vertical second linear portion located on said second edge and extending between said top second end and said plurality of serrated teeth extending along said second edge; and
said substantially vertical second linear portion having a second linear portion edge.

18. The root cutting shovel of claim 16 further comprising:
a substantially vertical second linear portion located on said second edge and extending between said top second end and said plurality of serrated teeth extending along said second edge;
said substantially vertical second linear portion having a second linear portion edge.

19. The root cutting shovel of claim 15 wherein:
said head tip has a head tip edge.

20. A root cutting shovel comprising:
a concave head of a predetermined size and shape having a top and a tip;
said head having a front face and a rear face;
said tip having a tip edge;
said top having a first end and a second end;
said top having a center located between said first end and said second end;
a first edge extending from said head first end to said tip;
a second edge extending from said head second end to said tip;
a plurality of serrated teeth extending along said first edge;
a plurality of serrated teeth extending along said second edge;
each serrated tooth extending along said first edge having a first side and a second side which join together to form an apex;
a sixty degree angle formed by said each serrated tooth first side and said tooth second side on said first edge joining together;
each serrated tooth extending along said second edge having a first side and a second side which join together to form an apex;
a sixty degree angle formed by said each serrated tooth first side and said tooth second side on said second edge joining together;
each serrated tooth along said first edge having a tooth edge;
each serrated tooth along said second edge having a tooth edge;
a substantially vertical first linear portion located on said first edge and extending between said top first end and said plurality of serrated teeth extending along said first edge;
said substantially vertical first linear portion having a first linear portion edge;
a substantially vertical second linear portion located on said second edge and extending between said top second end and said plurality of serrated teeth extending along said second edge;
said substantially vertical second linear portion having a second linear portion edge;
an elongated handle secured to said top center of said head;
a first flange located on said top between said first end and said center wherein said first flange extends a predetermined distance from said head front face; and
a second flange located on said top between said second end and said center wherein said second flange extends a predetermined distance from said head front face.
